(19) United States
(12) Patent Application Publication
(10) Pub. No.: US 2007/0213881 A1
(43) Pub. Date: Sep. 13, 2007

(54) Liquid cooling of electronic device environments

(76) Inventors: Christian L. Belady, Richardson, TX (US); Christopher G. Malone, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/370,448

(22) Filed: Mar. 8, 2006

(51) Int. Cl. G05D 23/00

(52) U.S. Cl. 700/300; 361/687

(57) ABSTRACT

In one embodiment, a system comprises one or more electronic components, one or more coolant sources, one or more coolant supply lines in fluid communication with the one or more coolant sources, a heat exchanger in thermal communication with the coolant supply lines and the one or more electronic components; one or more coolant distribution units to regulate the flow of coolant through the one or more coolant supply lines, and an environment management unit communicatively coupled to the one or more electronic components and the one or more coolant distribution units, wherein the environment management unit regulates coolant flow through the one or more coolant supply lines according to one or more environmental parameters proximate the one or more electronic components.

### TECHNICAL FIELD

This application relates to electronic computing and more particularly to liquid cooling of electronic device environments.

### BACKGROUND

Computing and electronic devices generate heat during operation. Excessive heat may damage components of computing and electronic devices. Heat management has become a serious issue in data centers that include a large number of computing devices, particularly when the devices are housed in racks. Conventional heat management techniques in data centers utilize air conditioning units to attempt to maintain an acceptable ambient air temperature in the data center. More refined heat management approaches may find utility in the computing arts.

### SUMMARY

In one embodiment, a system comprises one or more electronic components, one or more coolant sources, one or more coolant supply lines in fluid communication with the one or more coolant sources, a heat exchanger in thermal communication with the coolant supply lines and the one or more electronic components; one or more coolant distribution units to regulate the flow of coolant through the one or more coolant supply lines, and an environment management unit communicatively coupled to the one or more electronic components and the one or more coolant distribution units, wherein the environment management unit regulates coolant flow through the one or more coolant supply lines according to one or more environmental parameters proximate the one or more electronic components.

### BRIEF DESCRIPTION OF THE DRAWINGS

FIG. 1 is a schematic illustration of a system for liquid cooling of electronic device environments, according to an embodiment.

FIGS. 2A-2B are schematic illustrations of coolant distribution units in a system for liquid cooling of electronic device environments, according to embodiments.

FIG. 3 is a schematic illustration of a rack in a system for liquid cooling of electronic device environments, according to an embodiment.

FIG. 4 is a flowchart illustrating operations in a method for liquid cooling of electronic device environments.

FIG. 5 is a schematic illustration of a system for liquid cooling of electronic device environments, according to an embodiment.

FIG. 6 is a schematic illustration of a system for liquid cooling of electronic device environments, according to an embodiment.

FIG. 7 is a flowchart illustrating operations in a method for liquid cooling of electronic device environments.

### DETAILED DESCRIPTION

Disclosed are systems and methods for liquid cooling of electronic device environments. As is described in the following, aspects of the methods may be embodied as logic instructions stored in a suitable memory module. When executed by a processor, the logic instructions cause the processor to initiate a processor load routine and to collect temperature gradient data during the load routine.

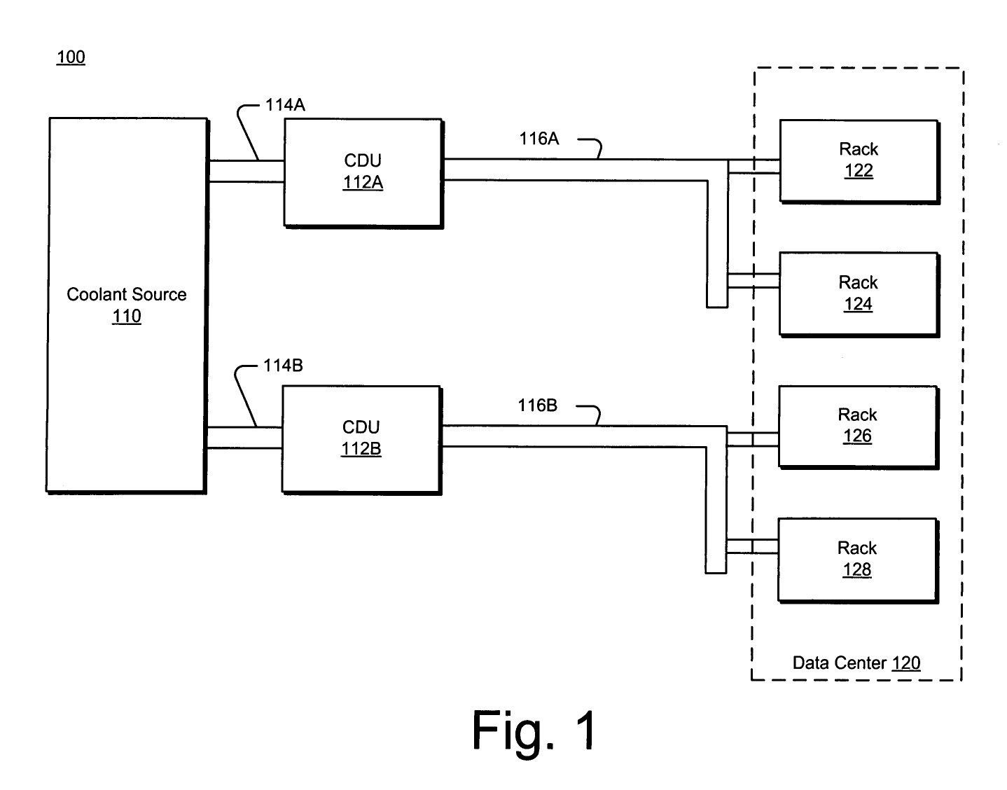

FIG. 1 is a schematic illustration of a system for liquid cooling in data centers, according to an embodiment. Referring to FIG. 1, in one embodiment, a system 100 for liquid cooling in data centers includes a coolant source 110 in fluid communication with one or more coolant distribution units 112A, 112B, which are in fluid communication with one or more electrical component racks 122-128 in a data center 120. In one embodiment the coolant may include a suitable fluid coolant such as water or a suitable refrigerant. Further, the system 100 may implement a single-phase coolant flow or a two-phase coolant flow.

Coolant distribution units 112A, 112B are in fluid communication coolant source 110 via fluid communication lines 114A, 114B and with data center 120 via fluid communication lines 116A, 116B. In one embodiment, fluid communication lines 114A, 114B and 116A, 116B, may be embodied as conventional fluid pipes, and may include separate supply lines and return lines.

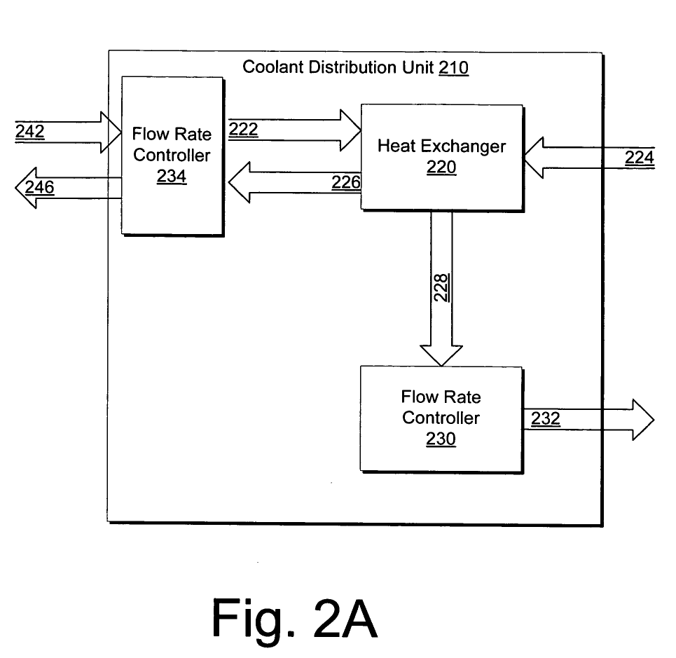

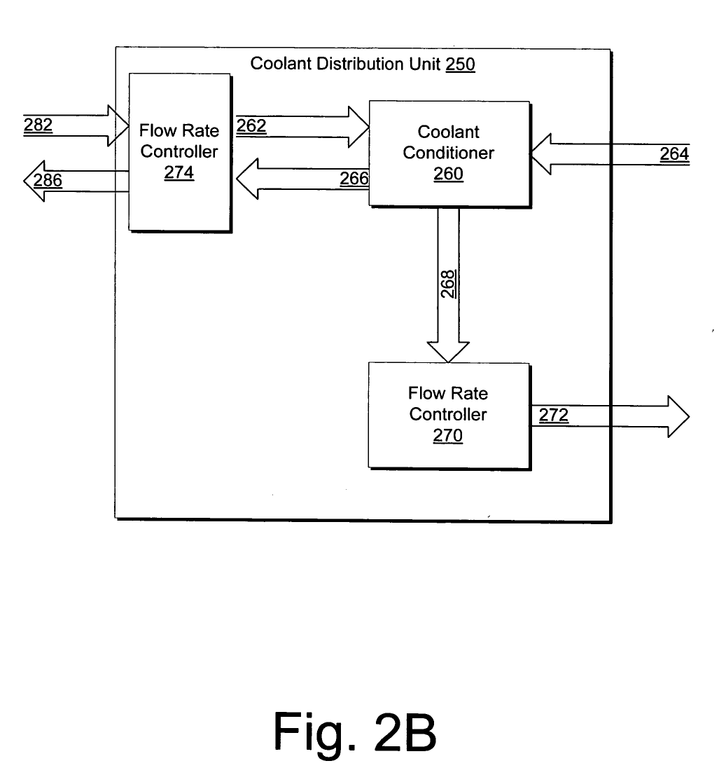

FIGS. 2A-2B are schematic illustrations of coolant distribution units in a system for liquid cooling in data centers, according to embodiments. The coolant distribution units 210, 250 depicted in FIGS. 2A and 2B, respectively, may correspond to one or more of the coolant distribution units 112A, 112B depicted in FIG. 1.

Referring to FIG. 2A, in one embodiment a coolant distribution unit 210 comprises a heat exchanger 220 and a flow rate controller 230. Heat exchanger 220 may receive a first cooling fluid from a flow rate controller 234 from an input 222. Cooling fluid from one of the fluid communication lines 116A, 116B may be received in an input 224. Heat exchanger 220 may include a radiator, fans, or other mechanisms to transfer heat from the fluid input 224 to the fluid input at 222. Cooled fluid is released from heat exchanger at output 228, while heated fluid is released at output 226. Flow rate controller 234 controls the flow rate of the cooling fluid injected at input 222. The cooled fluid output at 228 may be directed to a flow rate controller 230, which controls the rate of fluid flow from output 232. Flow rate controller 234 may receive a fluid input from a supply line 242 and a return line 246. In one embodiment, supply line 246 may deliver chilled fluid such as, e.g., water, from a building chilled water supply. In alternate embodiments, supply line 242 and return line 246 may bypass flow rate controller 234, or flow rate controller 234 may be omitted entirely.

Referring briefly to FIG. 2B, in another embodiment a coolant distribution unit 210 includes a fluid conditioner 260 and a flow rate controller 270. Fluid conditioner 260 receives a fluid such as, e.g., water or a refrigerant in an input 264. Fluid conditioner 260 may compress the refrigerant to a higher pressure to permit heat to be extracted from the refrigerant. Fluid conditioner 260 may include a compressor, heat exchanger, and/or fans to facilitate such heat exchange. Optionally, coolant conditioner 260 may receive a first cooling fluid from a flow rate controller 274 from an input 262. The cooling fluid may be used to transfer heat from coolant conditioner. Flow rate controller 274 may receive a fluid input from a supply line 282 and a return line 286. In one embodiment, supply line 282 may deliver chilled fluid such as, e.g., water, from a building chilled water supply. In an alternate embodiment, supply line 282 may deliver one or more gasses such as, e.g., air, nitrogen, argon, or the like.

In one embodiment, refrigerant expelled from output 268 is directed to a flow rate controller 270. Flow rate controller 270 may include one or more monitoring devices, adjustable valves and/or pumps to control the flow of refrigerant 228 from coolant distribution unit 210. In alternate embodiments, supply line 282 and return line 286 may bypass flow rate controller 274, or flow rate controller 274 may be omitted entirely.

Referring briefly back to FIG. 1, the coolant output from coolant distribution units 112A, 112B is transported through fluid communication lines 116A, 116B, respectively to the electrical component racks 122-128 in data center 120. In one embodiment, data center 120 may include a defined section or area of a building, corporate campus, or the like. In practice, many data centers are physically segregated from the surrounding environment by walls, partitions, and the like, however, such physical segregation is not a requirement. In one embodiment, electrical component racks 122-128 may include one or more enclosed servers such as, for example, a ProLiant model server or an Integrity model server commercially available from Hewlett Packard Corporation of Palo Alto, Calif., USA. In addition, the electrical component racks 122-128 may include other components such as, for example, storage devices such as hard disks, optical drives, and the like, power supplies, or other components.

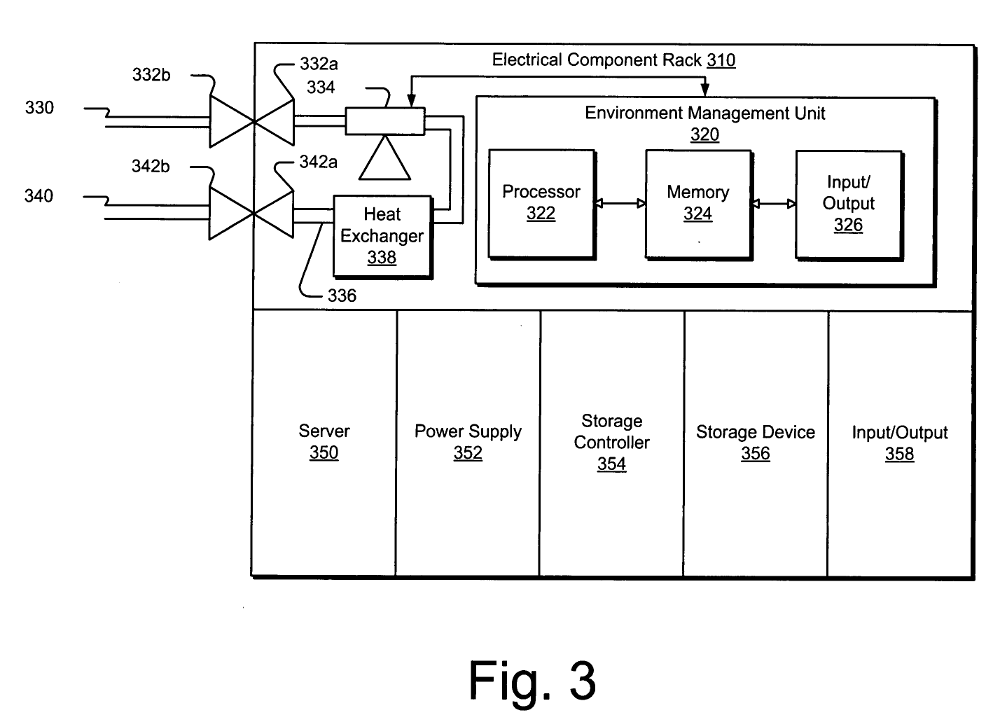

FIG. 3 is a schematic illustration of an electrical component rack in a system for liquid cooling in data centers, according to an embodiment. Referring to FIG. 3, electrical component rack 310 may include one or more servers 350, power supplies 352, storage controllers 354, one or more storage devices 356, and one or more input/output modules 358. Electrical component rack 310 may further include a backplane or other suitable communication bus to permit communication between components on the rack 310.

Electrical component rack 310 receives coolant via an input 330. In one embodiment, electrical component rack 310 may include a coupling 332a that mates with a corresponding coupling 332b to connect the electrical component rack 310 to the input 330. Electrical component rack 310 may further include a dynamic valve 334 to regulate the flow of coolant through electrical component rack. Coolant that enters electrical component rack 310 flows through fluid communication line(s) 336 in electrical component rack 310 and is returned to a coolant distribution unit 112A, 112B via output 340, which is coupled to electrical component rack 310 by a coupling 342a, 342b. Fluid communication line(s) 336 are coupled to a heat exchanger 338, which may be embodied as a coolant-to-liquid heat exchanger, a coolant-to-gas heat exchanger, or a gas-to-gas heat exchanger.

Electrical component rack 310 may further include an environment management unit 320. In one embodiment, environment management unit 320 is adapted to monitor and/or determine one or more environmental parameters in the environment of electrical component rack. Exemplary parameters may include a temperature proximate one or more electrical components in the rack 310, a temperature differential between the environment in the rack and an external environment, or between environments in the rack, a humidity, a dew point, or the like internal temperature, external temperature, altitude and the like. Environment management unit 320 may control dynamic valve 334 to regulate coolant flow through the coolant supply line(s) 336 according to at least one environmental parameter in the rack 310 environment. In one embodiment, environment management unit 320 is communicatively coupled to dynamic valve 334, e.g., by the backplane or by a suitable communication bus.

In one embodiment, environment management unit 320 may include a temperature detection device such as, e.g., a thermistor, thermocouple, or the like to detect a temperature in the environment. Thermal management unit 320 may further include a processor 322 and a memory module 324, a field programmable gate array (FPGA), a digital signal processor (DSP), an analog to digital converter (ADC) or the like.

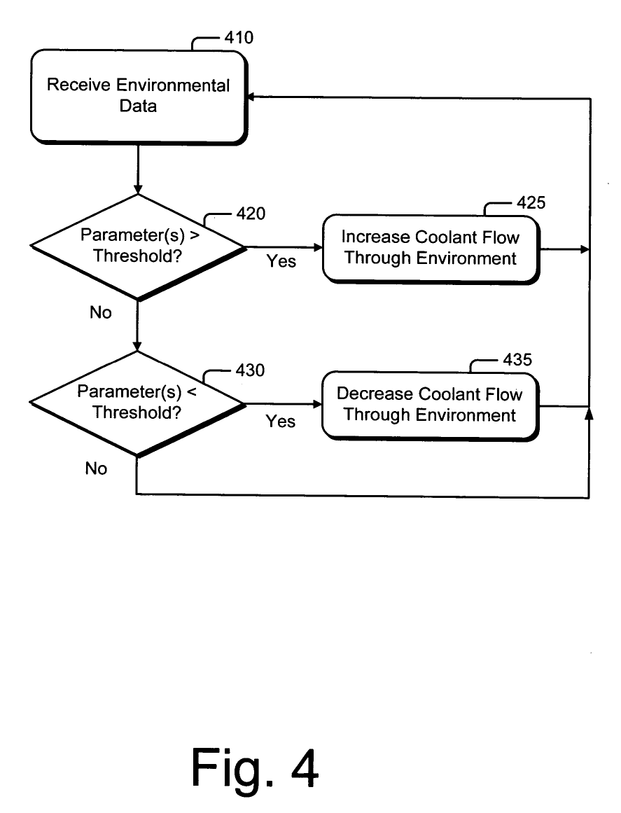

In one embodiment, memory module 324 comprises logic instructions which, when executed by the processor 322, cause the processor to regulate the flow of coolant through fluid communication lines 336 according to a temperature detected in the environment of electrical component rack. FIG. 4 is a flowchart illustrating operations in a method for liquid cooling of electronic device environments. In one embodiment, logic instructions in memory module 324 may cause processor 322 to execute the operations illustrated in FIG. 4.

Referring to FIG. 4, at operation 410 the processor 322 receives data about one or more environmental parameters in the environment of electrical component rack 310. In one embodiment, at operation 410, processor 322 receives temperature data detected by one or more temperature detection device(s) in or proximate electrical component rack 310. In an alternate embodiment, processor receives temperature data collected at various points in time by one or more temperature detection device(s) in or proximate electrical component rack 310 and aggregates the data into a time-averaged reading. In an alternate embodiment, one or more of the electronic devices such as server 350, power supply 352, storage controller 354, or storage device 356 may include a temperature detection device, and the processor 322 may receive temperature data from multiple devices in the environment of electrical component rack 310 and determine an average temperature reading. In addition, it may use policies and/or individual thresholds to take action. These thresholds and policies may change as a function of workloads and statistical workload behavior. To expand further, it can have broader policies for multiple racks and/or servers were policies can optimize the coolant distribution based on policies at the data center level. In alternate embodiments, the processor may receive environmental data relating to other environmental parameters such as, e.g, humidity or the like. In alternate embodiments, the processor may receive environmental data pertaining to one or more qualities of the cooling fluid such as, e.g., contamination levels, vapor content and the like.

If, at operation 420 one or more environmental parameters received in operation 410 are greater than an upper threshold, then control passes to operation 425 and the flow of coolant through the environment may be increased. The upper threshold may be static, e.g., determined by a manufacturer or distributor or operator of electrical component rack and encoded into memory 324. Alternatively, the upper threshold may be determined dynamically, or by operating parameters of the electronic components housed in rack 310. Alternatively, the threshold may be a component of an environment management policy. In one embodiment, if the environmental parameter(s) exceeds the upper threshold, then the processor generates instructions which cause the dynamic valve 334 to increase the flow of coolant through the environment of electrical component rack.

If, at operation 420, the environmental parameter(s) do not exceed an upper threshold, then control passes to operation 430. If, at operation 430 the environmental parameter(s) is beneath a lower threshold, then control passes to operation 435 and the flow of coolant through the environment is decreased. The lower threshold may be static, e.g., determined by a manufacturer or distributor or operator of electrical component rack and encoded into memory 324. Alternatively, the lower threshold may be determined dynamically, or by operating parameters of the electronic components housed in rack 310. In one embodiment, if the environmental parameter(s) are beneath the lower threshold, then the processor generates instructions which cause the dynamic valve 334 to decrease the flow of coolant through the environment of electrical component rack.

Following execution of either operation 425 or operation 435, control returns to operation 410. A suitable time delay may be implemented before execution of operation 410. Thus, operations 410-435 constitute a control loop by which the environment management unit regulates coolant flow through the coolant supply lines 336 in the electrical component rack 310 according to one or more environmental parameters in the environment of the electrical components on the rack 310.

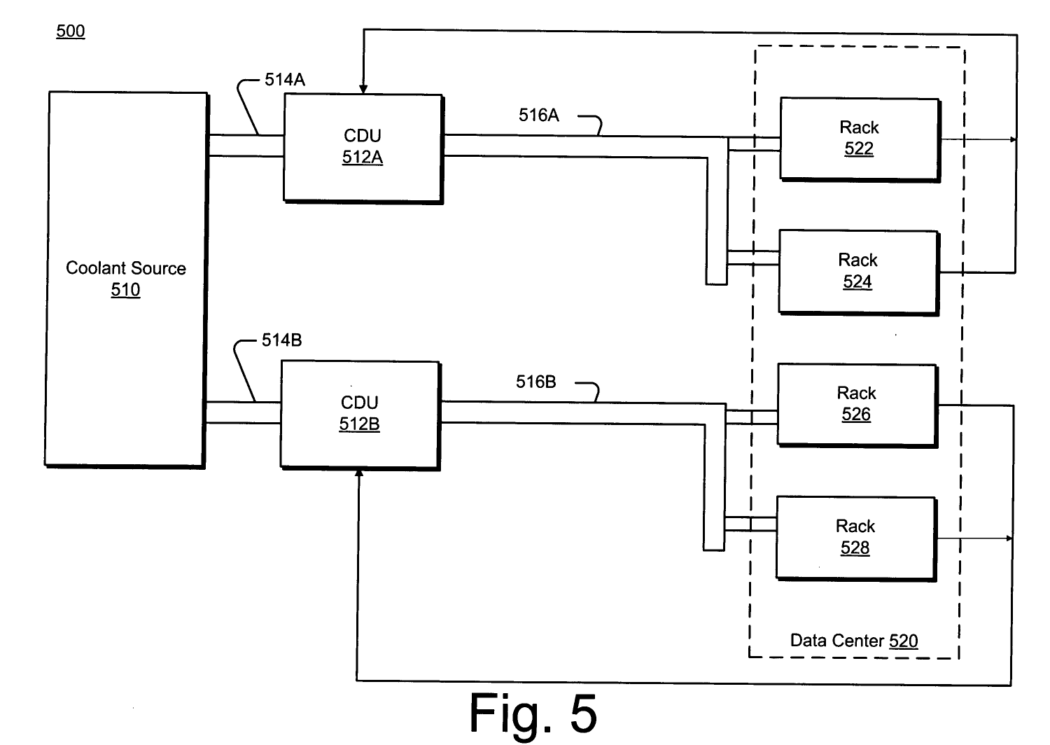

FIG. 5 is a schematic illustration of a system 500 for liquid cooling of electronic device environments, according to an embodiment. The components of the system depicted in FIG. 5 are substantially similar to the components illustrated in FIG. 1, and like components are numbered in a like fashion. The system of FIG. 5 includes communication paths from the electrical component rack(s) 522-528 in the data center to the coolant distribution unit(s) 512A, 512B. The communication path may be implemented by any suitable communication bus, link, or connection, wired or wireless, and pursuant to any suitable protocol. In one embodiment, the communication paths provide a communication link between a thermal management unit 320 in the racks 522-528 and the coolant distribution units 512A, 512B.

The embodiment depicted in FIG. 5 may implement a control loop analogous to the control loop depicted in FIG. 4. However, in lieu of (or in addition to) controlling fluid flow to the electrical component racks by regulating dynamic valve 334, the embodiment depicted in FIG. 5 may control the fluid flow to the electrical component rack groups by regulating fluid flow at the coolant distribution units, or by regulating the operating conditions of the electrical components. In one embodiment, if one or more environmental parameters exceed an upper threshold, then the processor 322 generates instructions which cause one or more of the flow rate controllers 230, 270 in the coolant distribution units 210, 250 to increase the flow of coolant through the environment of electrical component racks 522-528. Conversely, if one or more environmental parameters are beneath a lower threshold, then the processor 322 generates instructions which cause one or more of the flow rate controllers 230, 270 in the coolant distribution units 210, 250 to decrease the flow of coolant through the environment of electrical component racks 522-528.

In an alternate embodiment, an environment management unit 320 may be located in the coolant distribution units 512A, 512B, in lieu of or in addition to an environment management unit in the rack 310. In this embodiment, one or more parameters pertaining to the environment of the electrical components in the rack may be communicated to the environment management unit via the communication links with the coolant distribution units 512A, 512B.

Thus, in the context of the embodiment depicted in FIG. 5, the operations 410-435 constitute a control loop by which the coolant distribution units regulate coolant flow to the electrical component racks 522-528 according to one or more environmental parameters in the environment of the electrical components on the racks 522-528.

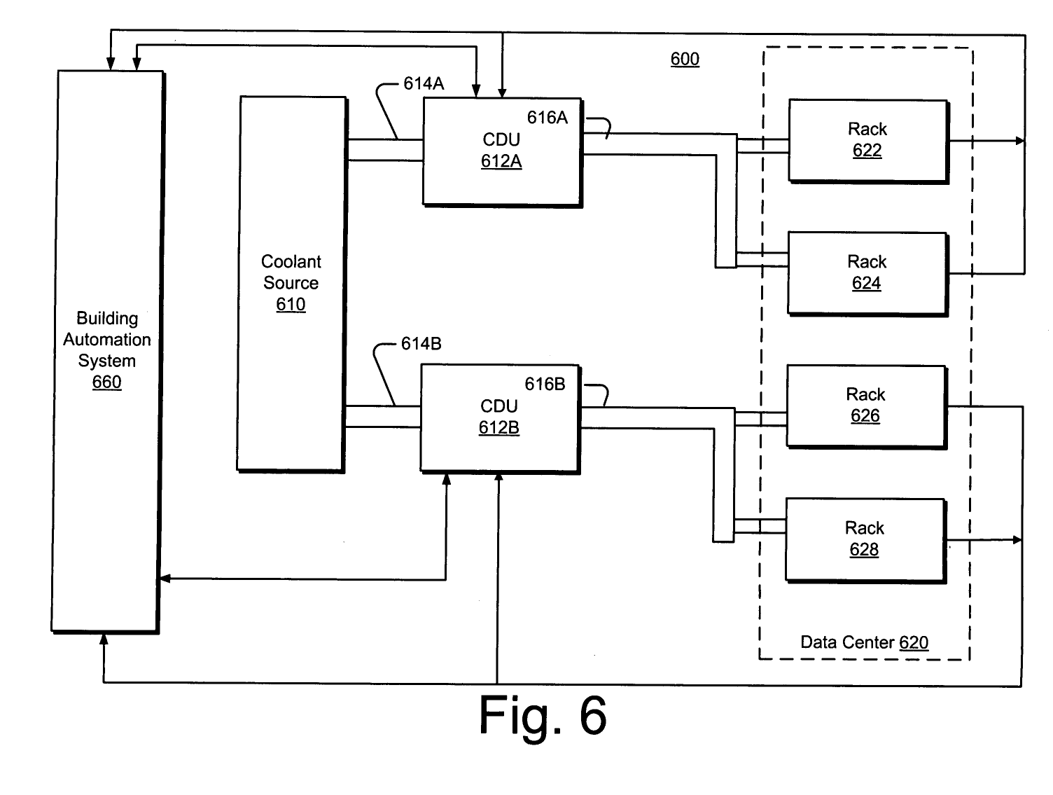

FIG. 6 is a schematic illustration of a system 600 for liquid cooling of electronic device environments, according to an embodiment. The components of the system depicted in FIG. 6 are substantially similar to the components illustrated in FIG. 1, and like components are numbered in a like fashion. The system of FIG. 6 includes communication paths from the electrical component rack(s) 622-628 in the data center 620 to the coolant distribution unit(s) 612A, 612B. In addition, the system of FIG. 6 includes communication paths from the electrical component rack(s) 622-628 in the data center 620 to a building automation system 660. Further, the system 600 includes a communication path from the coolant distribution units 612A, 612B to the building automation system 660. The communication paths may be implemented by any suitable communication bus, link, or connection, wired or wireless, and pursuant to any suitable protocol. In one embodiment, the communication paths provide a communication link between a thermal management unit 320 in the racks 622-628 and the coolant distribution units 612A, 612B and the building automation system 660.

The embodiment depicted in FIG. 6 may implement a control loop analogous to the control loop depicted in FIG. 4 in the manner described with reference to FIGS. 1 and 5. In the embodiment depicted in FIG. 6, thermal management unit 320 (or operations thereof) may be moved to the building automation system 660. In addition, the building automation system 660 may monitor and control the coolant distribution units to ensure that the capacity of the coolant distribution units is not exceeded. In one embodiment, the building automation system 660 may balance the cooling load between the coolant distribution units 612A, 612B if policies require.

Thus, in the context of the embodiment depicted in FIG. 6, the operations 410-435 constitute a control loop by which the thermal management unit regulates coolant flow through the coolant supply lines 336 in the electrical component rack 310 according to one or more environmental parameters in the environment of the electrical components on the rack 310.

In another embodiment, the building automation system 660 may monitor flow rates, environmental parameters, and capacity parameters for the racks 622-628, and may dynamically adjust flow rates to match cooling and/or computing demands of the racks 622-628. Building automation system 660 may further adjust flow rates based on parameters such as, e.g., the priority assigned to a computing application, an energy management goal, or the like. Adroit use of a building automation system 660 can reduce the need for overprovisioning of fluid and match the amount of coolant needed to maximize efficiency and thus optimize on energy efficiency in a data center.

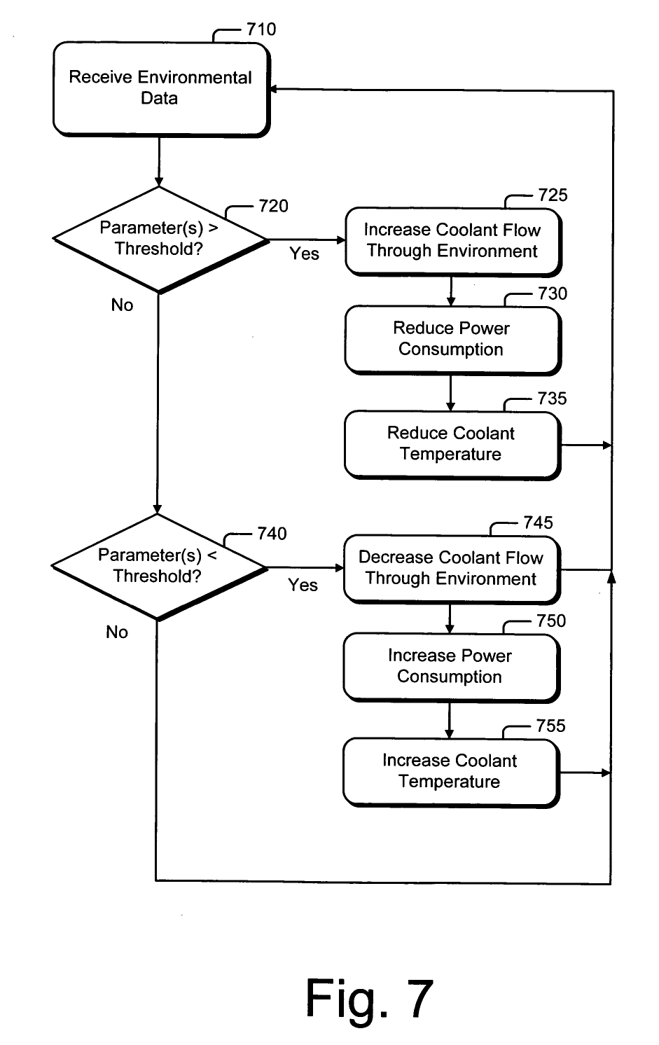

FIG. 7 is a flowchart illustrating operations in a method for liquid cooling of electronic device environments. In the embodiment depicted in FIG. 1, the operations illustrated in FIG. 7 may be implemented by the environment management unit 320. Hence, logic instructions in memory module 324 may cause processor 322 to execute the operations illustrated in FIG. 7. In alternate embodiments (see, FIGS. 5-6), the environment management unit 320 or an analogous structure may be implemented in the coolant distribution unit 512A, 512B. In alternate embodiments (see, FIG. 6), the thermal management unit 320 or an analogous structure may be implemented in the building automation system 660 may cause a processor to execute the operations illustrated in FIG. 7. In yet another embodiment, the environment management unit 320 may be distributed between one or more of the racks 310, the coolant distribution unit(s) 512A, 512B, and the building automation system 660.

Referring to FIG. 7, at operation 710 the processor 322 receives one or more environmental parameters relating to the in the environment of electrical component rack 310. In one embodiment, at operation 710, processor 322 receives environmental parameters relating to the environment of the electrical component rack(s) 310. In one embodiment, processor 322 receives one or more environmental parameters collected at various points in time by the environment management unit 320 and aggregates the data into a time-averaged reading. In an alternate embodiment, one or more of the electronic devices such as server 350, power supply 352, storage controller 354, or storage device 356 may include a temperature detection device, and the processor 322 may receive temperature data from multiple devices in the environment of electrical component rack 310 and determine an average temperature reading. In alternate embodiments, the environmental parameters may include additional parameters such as, e.g., humidity measurements and operating parameters associated with the electronic devices such as, e.g., operating speeds, processor utilization measurements, and the like.

If, at operation 720 one or more environment parameters in the environment of electrical component rack 310 is greater than an upper threshold, then one or more of operations 725-735 may be executed. The upper threshold may be static, e.g., determined by a manufacturer or distributor or operator of electrical component rack and encoded into memory 324. Alternatively, the upper threshold may be determined dynamically, or by operating parameters of the electrical components housed in rack 310.

At operation 725 the flow of coolant through the environment may be increased. Techniques for increasing the flow of coolant are described above. Optionally, prior to increasing the coolant flow the capacity of the cooling system may be analyzed to determine whether there is capacity to increase the flow of coolant. If the cooling system lacks capacity, then an error routine may be invoked. In one embodiment, an error routine may include presenting a warning message on a user interface such as, e.g., a display or the like.

At operation 730 the power consumption of one or more electrical components in the rack may be reduced. In one embodiment, the power consumption may be reduced by cutting the operating power consumed by the electrical components in the rack 310, e.g., by changing the power state of one or more processors or by reducing the operating speed of one or more processors. In another embodiment, the power consumption may be reduced by cutting the output of a power supply such as power supply 352. Power supply decisions may be made in an intelligent fashion. For example, electronic devices executing critical applications may remain operating at full power, while electronic devices executing non-critical applications may have their power state or operating speed reduced.

At operation 735 the temperature of the coolant may be reduced. In one embodiment the coolant temperature may be reduced by reducing the temperature of the input fluid 222 in the coolant distribution unit. In another embodiment the temperature of the coolant may be reduced by increasing the duty cycle of the compressor in the fluid conditioner 260 in coolant distribution unit 250. In yet another embodiment, the temperature of the coolant may be reduced by increasing the fluid flow of the flow rate controllers 234, 274.

If, at operation 720, the one or more environment parameters does not exceed an upper threshold, then control passes to operation 740. If, at operation 740 the temperature reading is beneath a lower threshold, then control passes to operation 745 and the flow of coolant through the environment may be decreased. The lower threshold may be static, e.g., determined by a manufacturer or distributor or operator of electrical component rack and encoded into memory 324. Alternatively, the lower threshold may be determined dynamically, or by operating temperature parameters of the electronic components housed in rack 310.

Techniques for decreasing the flow of coolant are described above. At operation 750 the power consumption of one or more electrical components in the rack may be increased. In one embodiment, the power consumption may be increased by increasing the operating power consumed by the electrical components in the rack 310. In another embodiment, the power consumption may be increased by increasing the output of a power supply such as power supply 352. At operation 755 the temperature of the coolant may be increased. In one embodiment the coolant temperature may be increased by increasing the temperature of the input fluid 222 in the coolant distribution unit. In another embodiment the temperature of the coolant may be increasing by reducing the duty cycle of the compressor in fluid conditioner 260 in coolant distribution unit 250, thereby decreasing the temperature of the coolant in output 272.

Thus, in the context of the embodiment depicted in FIGS. 1 and 5-6, the operations 710-755 constitute a control loop by which the environment management unit (or equivalent structure) regulates an environmental parameter in an electrical component rack 310 by regulating one or more of a coolant flow through the coolant supply lines 336 in the electrical component rack 310, a coolant temperature, or power consumption according to a temperature in the environment of the electrical components on the rack 310. In another embodiment, the building automation system 660 may monitor flow rates, temperature and capacity parameters for the racks 622-628 and may dynamically adjust flow rates to match cooling demands of the racks 622-628.

The systems described herein may implement control routines that manage an environmental parameter such as, for example, a temperature parameter. Control routines may also manage power consumption by the electrical components to achieve target processing rates. Control routines may also manage coolant temperatures and/or flow rates to satisfy cooling requirements in an energy-efficient manner. This enhances computational and application priorities and could throttle based on demands.

In embodiments, the logic instructions illustrated in FIGS. 4 and 7 may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least one implementation. The appearances of the phrase “in one embodiment” in various places in the specification are not necessarily all referring to the same embodiment.

What is claimed is:

1. A system, comprising:
one or more electronic components;
one or more coolant sources;
one or more coolant supply lines in fluid communication with the one or more coolant sources
a heat exchanger in thermal communication with the coolant supply lines and the one or more electronic components;
one or more coolant distribution units to regulate the flow of coolant through the one or more coolant supply lines; and
an environment management unit communicatively coupled to the one or more electronic components and the one or more coolant distribution units, wherein the environment management unit regulates coolant flow through the one or more coolant supply lines according to one or more environmental parameters proximate the one or more electronic components.

2. The system of claim 1, further comprising a rack for housing the one or more electronic components, wherein the fluid supply lines extend along portions of the rack, and the coolant distribution units regulate a flow of coolant to the rack.

3. The system of claim 2, wherein:
the one or more electronic components includes a environment management unit; and
the environment management unit is communicatively coupled to the one or more electronic components and the coolant distribution units.

4. The system of claim 2, wherein the environment management unit regulates the operation of the one or more electronic components according to an environmental parameter proximate the one or more electronic components.

5. The system of claim 2, wherein the coolant distribution unit cools the coolant.

6. The system of claim 4, wherein the coolant distribution unit comprises a heat exchanger or a coolant conditioner.

7. The system of claim 5, wherein the coolant distribution unit is communicatively coupled to a building automation system.

8. The system of claim 5, wherein the environment management unit is communicatively coupled to a building automation system.

9. A method, comprising:
monitoring one or more environmental parameters of an environment proximate one or more electronic components; and
regulating a coolant fluid flow in the environment proximate the plurality of electronic components according to the one or more environmental parameters.

10. The method of claim 9, further comprising regulating operation of the one or more electronic components according to the one or more environmental parameters.

11. The method of claim 9, wherein regulating a fluid flow in the environment proximate the plurality of electronic components according to the one or more environmental parameters comprises controlling the operation of one or more valves according to the one or more environmental parameters.

12. The method of claim 9, wherein regulating operation of the one or more electronic components according to the temperature comprises at least one of managing a power consumption of one or more electronic components or managing an operating speed of one or more electronic components.

13. The method of claim 9, further comprising regulating operations of a fluid conditioner according to the one or more environmental parameters.

14. A computer program product comprising logic instructions stored on a computer-readable medium which, when executed by a processor, configure the processor to:
monitor one or more environmental parameters of an environment proximate one or more electronic components; and
regulate a coolant fluid flow in the environment proximate the plurality of electronic components according to the one or more environmental parameters.

15. The computer program product of claim 14, further comprising logic instructions which, when executed by the processor, configure the processor to regulate operation of the one or more electronic components according to the one or more environmental parameters.

16. The computer program product of claim 15, further comprising logic instructions which, when executed by the processor, configure the processor to control the operation of one or more valves that regulate coolant flow through the environment according to the one or more environmental parameters.

17. The computer program product of claim 16, further comprising logic instructions which, when executed by the processor, configure the processor to reduce an operating speed of one or more electronic components.

18. The computer program product of claim 16, further comprising logic instructions which, when executed by the processor, configure the processor to regulate operations of a heat exchanger according to the one or more environmental parameters.

19. The computer program product of claim 18, further comprising logic instructions which, when executed by the processor, configure the processor to regulate operations of a heat exchanger according to the one or more environmental parameters.

20. The computer program product of claim 18, further comprising logic instructions which, when executed by the processor, configure the processor to implement a control algorithm that avoids over provisioning of coolant resources to efficiently use energy.
